(19) United States
(12) Patent Application Publication
(10) Pub. No.: US 2010/0229610 A1
(43) Pub. Date: Sep. 16, 2010

(54) Locking Device Using Shape Memory Materials

(75) Inventors: Sean Patrick Garrigan, Beavercreek, OH (US); Teresa Ellen Havens, Bellbrook, OH (US); David Ernest Havens, Bellbrook, OH (US)

Correspondence Address: CORNERSTONE RESEARCH GROUP, INC., 2750 INDIAN RIPPLE ROAD, DAYTON, OH, 45440, US

(73) Assignee: CORNERSTONE RESEARCH GROUP, INC., Dayton, OH (US)

(21) Appl. No.: 12/304,002

(22) PCT Filed: Jun. 25, 2007
(86) PCT No.: PCT/US07/72046

§ 371 Date: Dec. 9, 2008

Related U.S. Application Data
(60) Provisional application No. 60/805,627, filed on Jun. 23, 2006.

(51) Int. Cl. E05B 65/00

(52) U.S. Cl. 70/174

(57) ABSTRACT

The disclosed devices use shape memory materials, and specifically shape memory polymers and composites to allow or disallow mechanical or physical movement. By positioning the shape memory polymer so it is near the mechanical device which is to be moved, the shape memory polymer will allow or disallow the motion of the mechanical device depending on the state the shape memory polymer is in. When the shape memory polymer is in its hard rigid state the device cannot move. Once activated the shape memory polymer will become soft and pliable, whereupon with sufficient force the mechanical device can be moved to a new position. Once in this new position the SMP can either remain in its relaxed state, the SMP can return to a hard rigid state and maintain its deformed shape, or the SMP can return to its original shape to ensure the device does not move.

### CROSS REFERENCE TO RELATED APPLICATIONS

This application claims priority from U.S. Provisional Application Ser. No. 60/805,627 filed Jun. 23, 2006.

### STATEMENT REGARDING FEDERALLY SPONSORED RESEARCH

This application was made in part with government support under contract number FA8650-05C-5047 awarded by the United States Air Force DET 1 AF Research Laboratory. The government may have certain rights in this application.

### BACKGROUND OF THE INVENTION

Mechanical systems require complex linkages and mechanisms to accomplish similar functionality. Solenoids, motors, hydraulic cylinders, valves and other similar types of these approaches are more complex and more expensive to build. Current electrical devices are typically very large to achieve adequate holding force however; these devices require constant power to maintain the lock resulting in low power efficiency. Smaller devices cannot obtain the large holding forces necessary for their applications. Mechanical systems require no power, but their complex design makes them very expensive and difficult to repair. Simple, long-lasting, and effective means of accomplishing these goals is a long sought after desire which shape memory materials can solve.

Shape memory polymers (SMPs) and shape memory alloys (SMA) were first developed about 20 years ago and have been the subject of commercial development in the last 10 years. SMPs derive their name from their inherent ability to return to their original “memorized” shape after undergoing a shape deformation. SMPs that have been preformed can be deformed to any desired shape below or above its glass transition temperature (T(_{g})). If it is below the T(_{g}), this process is called cold deformation. When deformation of a plastic occurs above its T(_{g}), the process is denoted as warm deformation. In either case the SMP must remain below, or be quenched to below, the T(_{g}) while maintained in the desired thermoformed shape to “lock” in the deformation. Once the deformation is locked in, the polymer network cannot return to a relaxed state due to thermal barriers. The SMP will hold its deformed shape indefinitely until it is heated above its T(_{g}), whereat the SMP stored mechanical strain is released and the SMP returns to its performed state.

As used throughout this application, activating a shape memory material means transforming a shape memory material from a hard rigid state to a soft and pliable state.

As used throughout this application, deactivating a shape memory material means transforming a shape memory material form a soft and pliable state, to a hard and rigid state.

Several known polymer types exhibit shape memory properties. Probably the best known and best researched polymer type exhibiting shape memory polymer properties is polyurethane polymers. Gordon, Proc of First Intl. Conf. Shape Memory and Superelastic Tech., 115-120 (1994) and Tobushi et al., Proc of First Intl. Conf. Shape Memory and Superelastic Tech., 109-114 (1994) exemplify studies directed to properties and application of shape memory polyurethanes. Another polymeric system based on crosslinking polyethylene homopolymer was reported by S. Ota, Radiat. Phys. Chem. 18, 81 (1981). A styrene-butadiene thermoplastic copolymer system was also described by Japan Kokai, JP 63-179955 to exhibit shape memory properties. Polyisoprene was also claimed to exhibit shape memory properties in Japan Kokai JP 62-192440. Another known polymeric system, disclosed by Kagami et al., Macromol. Rapid Communication, 17, 539-543 (1996), is the class of copolymers of stearyl acrylate and acrylic acid or methyl acrylate. Other SMP polymers known in the art includes articles formed of norbornene or dimethaneoctahydronapthalene homopolymers or copolymers, set forth in U.S. Pat. No. 4,831,094. Additionally, styrene copolymer based SMPs are disclosed in U.S. Pat. No. 6,759,481 which is incorporated herein by reference.

The locking devices disclosed make use of several features of Shape Memory Polymer as a major component of the apparatus. First introduced in the United States in 1984, Shape Memory Polymers (“SMPs”) are polymers whose qualities have been altered to give them dynamic shape “memory” properties. Under thermal, electric, light, electromagnetic radiation, water, and other stimuli depending on the type of SMP desired for a particular use, SMP can exhibit a radical change from a rigid thermoplastic to a highly flexible, elastic state, then return to a rigid state again. In its elastic state, SMP will recover its “memory” shape if left unrestrained. The “memory,” or recovery, quality comes from the stored mechanical energy attained during the reconfiguration of the material. SMP's ability to change stiffness modulus and shape configuration at will makes SMP ideal for applications requiring lightweight, dynamic, and adaptable materials.

Unlike a shape memory alloy (SMA), SMPs exhibits a radical change from a normal rigid polymer to flexible elastic and back on command, a change that can be repeated without degradation of the material. The SMP transition process is a molecular relaxation rather than an induced crystalline phase transformation, as with SMA. In addition, SMP demonstrates much broader range and versatility than SMA in shape configuration and manipulation with SMPs being able to recover from strains of 400-600% or more and having a wide range of activation methods including heat, light, and water.

SMP's have a dynamic elastic modulus that, above a certain temperature, make the material soft and flexible. As shown in FIG. 10 and SMP's elastic modulus drops dramatically as the temperature nears and exceeds its transition temperature. Prior to the transition temperature the SMP is hard and inflexible. Above the transition temperature the SMP is soft and malleable. The range between solid and elastic state can be tailored so the temperature difference is as small or as large as desired.

The term “composite” is commonly used in industry to identify components produced by impregnating a fibrous material with a thermoplastic or thermosetting resin to form laminates or layers. Composites can be made with SMP resin. It will be appreciated that fibrous material such as carbon-carbon, carbon nano-tubes, cotton, spandex, carbon fiber, Parabeam® and other similar material could be used to make SMP composites.

The principal method of activating the SMP effect is by thermal energy. Typically this is accomplished by convection from and over or heat gun or from the resistance occurring when electrical current is passed through a resistive element. Other methods in addition to heat that are known to activate SMP resin including, but not limited to, visible and ultraviolet light, other forms of electromagnetic energy, water, and magnetic fields.

Previous attempts to use shape memory materials as a locking mechanism are described below. One example of the use of shape memory alloy in a coupling system is disclosed in U.S. Pat. No. 6,273,888 issued on Aug. 14, 2001 to Jeff Justis. The Justis patent describes a shape memory alloy coupling system for connecting two or more members and selectively preventing premature locking. The coupling system includes a coupling device adapted for connection to a member and been at least partially formed of a shape memory material. The coupling device has a first configuration that allows relative movement between the member and the coupling device, and a second configuration that limits relative movement between the member and the coupling device. A blocking element co-acts with the coupling device to selectively prevent the coupling device from assuming the second configuration. The drawback of the Justis patent is its use of shape memory alloy as well as the fact that this patent does not prevent or allow mechanical motion in so far as a traditional locking mechanism would.

A second use of shape memory alloy in a locking system is described in U.S. Pat. No. 4,880,343 issued on Nov. 14, 1989 to Hisao Matsumoto. The Matsumoto patent describes a locknut comprising a locked member prepared from a shape memory alloy and serving as a backup member for a fastening nut. The principal drawback of this patent is its reliance on shape memory alloys, which are expensive and cannot be used for any large-scale movement or locking mechanisms.

A third use of shape memory alloys in a locking system is described in U.S. Pat. No. 6,972,659 issued to Behrens et al. on Dec. 6, 2005. The Behrens patent describes a mechanical release mechanism including to structural members in slidable relation one to another. A latch holds one structural member in a latched position relative to the other structural member. A shape memory alloy member disposed within one of the structural members is used to move the latch holding the other structural member, thereby allowing relative motion between the structural members. When activated, the shape memory alloy member produces a linear activation force that moves the latch towards the surface of the second structural member to produce relative movement between the first structural member and second structural member. As with the previous two patents, the Behrens relies on shape memory alloy as its principal actuating force.

Finally in U.S. Pat. No. 6,871,519 issue to Butera and Alacqua on Mar. 29, 2005 a shape memory device for locking doors in described. As in previous patents discussed, the Butera and Alacqua patent uses shape memory wire as the actuation force for the mechanical lock, with a separate mechanism being needed to act as the locking mechanism.

As with all of the above patents, the shape memory alloy used provides relatively little motion to achieve the locking or unlocking of any mechanism. Additionally, the shape memory alloy does not act as the locking mechanism itself it merely. The shape memory alloy merely acts as the actuation force enabling the mechanisms to be locked or unlocked. These features require large amounts of engineering and costs to implement.

Therefore, there is a need in the art for a shape memory locking mechanism wherein the shape memory material is the locking device and requires little or no engineering skills to implement. Additionally, a device is needed utilizing the properties of shape memory materials that is cheap and effective at locking other mechanisms and devices.

### SUMMARY OF THE INVENTION

In view of the foregoing needs and problems the present device is used to overcome these problems and meet these needs. By using cheap shape memory polymers and other similar shape memory materials the overall costs of these locking devices can be dramatically reduced. Additionally, the energy requirements needed to activate or deactivate the shape memory polymers or shape memory materials are considerably lower than the maintenance costs needed to maintain most locking devices in good working order.

The principal means of accomplishing this is in using the shape memory polymer to allow or disallow mechanical or physical motion or movement. By positioning the shape memory polymer so that it is near the mechanical device which is to be moved, the shape memory polymer can be used to allow or disallow the motion of the mechanical device depending on the state the shape memory polymer (SMP) is in. When the shape memory polymer is in its hard rigid state the device cannot move. Once activated the shape memory polymer will become soft and pliable, whereupon with sufficient force the mechanical device can be moved to a new position. Once in this new position the SMP can either remain in its relaxed state, the SMP can return to a hard rigid state and its deform shape, or the SMP can return to its original locking shape to ensure the mechanical device does not move when undesired.

Those of skill in the art will be familiar with the various means of activating the SMP. While heating is the preferred method of activating the SMP, other methods of activating the SMP include visible light, ultraviolet light, infrared light, x-rays, magnetic Fields, electrically generated heat, and other forms of electromagnetic radiation. Additionally, other forms of activation can include water, methane, and other chemicals. Those of skill in this are can easily determine the preferred method of activating the SMP for the particular application.

Other objects, features and advantages of the invention will be apparent from the following detailed description taken in connection with the examples and accompanying drawings and are within the scope of the present invention.

### BRIEF DESCRIPTION OF THE DRAWINGS

FIG. 1 is a perspective view of a simple embodiment using a mechanical latch and a piece of SMP which will prevent that latch from moving so long as the latch remains in a hard rigid state.

FIG. 2 is a perspective view of a mechanical latch turning win the SMP is soft and pliable.

FIG. 3 is a perspective view of a mechanical latch which has returned to its original position after moving and wherein the SMP which once prevented its motion retains its deform shape until it is allowed to return to its memorized shape.

FIG. 4 is a perspective view of a second embodiment wherein a simple spring-loaded pushbutton could be used to activate some other of device, but is held in place by the hard piece of SMP.

FIG. 5 is a perspective view of the second embodiment wherein the spring-loaded pushbutton has been depressed, and the SMP is in a soft pliable state allowing the mechanism attached to the push button to be moved.

FIG. 6 is a perspective view of the second embodiment wherein the force holding these brings loaded pushbutton down has been removed and the mechanism has returned to its original position, but the SMP will retain its deform shape until allowed to return to its memorized shape.

FIG. 7A is a top-down view of a ratcheting cam held in place by a piece of SMP.

FIG. 7B is a perspective view of a third embodiment where in a piece of SMP holds a ratcheting cam in place while the SMP is in a hard rigid state.

FIG. 7C is a side view other ratcheting cam held in place by a piece of SMP.

FIG. 8A is a side view of the ratcheting cam moving and the SMP allowing the movement of the ratcheting cam while the SMP is in a soft pliable state.

FIG. 8B is a top-down view of the ratcheting cam moving, and the SMP allowing the movement of the ratcheting cam while the SMP is a soft pliable state.

FIG. 9 is a perspective view of another embodiment, where in the SMP shell acts as a separation device between to devices which are required to come into contact for action to occur.

FIG. 10 is a perspective view of this embodiment wherein the SMP shell is in a soft pliable state and with sufficient force allows the devices to come in the contact with each other.

### DETAILED DESCRIPTION OF EXEMPLARY EMBODIMENTS

Referring to the drawings in greater detail, the method of using Shape Memory Polymers (SMPs) as a locking device is disclosed herein. This invention simplifies mechanical design, lowers cost, extends lifetime, and minimizes vulnerability to intrusion. The SMP nano-composite locking pin will alleviate the need for a wire to be embedded within the shape memory polymer bar. In the current device, the wire impedes free movement of the shape memory polymer so that the percent recovery is decreased. Without the wire there will be full recovery to the shape memory polymer, causing the mechanical system to be fully engaged/disengaged.

Examples 1 and 2 below describe the exemplary methods of creating pre-form sheets of SMP which can be easily machined into the desired shape. Additionally SMP composites could be used due to their inherent strength of composites. In general, the preferred SMP is a styrene copolymer based SMP as described in U.S. Pat. No. 6,759,481 issued on Jul. 6, 2004 to Tong, which is herein incorporated by reference. Additionally other types of SMPs could be used including cyanate ester, polyurethane, polyethylene homopolymer, styrene-butadiene, polyisoprene, copolymers of stearyl acrylate and acrylic acid or methyl acrylate, norbornene or dimethaneoctahydronapthalene homopolymers or copolymers, maleimide and other materials are within the scope of the present invention. Additionally shape memory alloys (SMA) are also within the scope of the present invention.

### Example 1

A polymeric reaction mixture was formulated by mixing vinyl neodecanoate (7%), divinyl benzene (1%), and styrene (90%) in random order to yield a clear solution. Benzoyl peroxide (2%) was then added to the resulting solution (all composition % are by weight). The resulting solution was kept cold in a refrigerator before use. To prepare the shape memory polymer (SMP), the reaction mixture formulated above was placed in a flat mold. The mixture is then heated in an oven maintained at atmospheric pressure and a temperature of 75° C. for 24 hours. After the material is cured for the specified period of time, it is removed from the oven and allowed to dry and cool down to room temperature. The material is removed from the mold and cut into the desired shapes.

### Example 2

A polymeric reaction mixture was formulated by mixing vinyl neodecanoate (7%), divinyl benzene (1%), and styrene (60%) in random order to form a colorless solution. Polystyrene granules (30%) were then added to the resulting solution. The resulting mixture was then allowed to sit at room temperature with occasional stirring until all the polystyrene granules were dissolved to give a clear, viscous solution. Benzoyl peroxide (2%) was then added to the resulting solution (all composition % are by weight). The resulting mixture is ultrasonicated at room temperature for 15 minutes to yield a clear solution. The resulting solution is kept cold in a refrigerator before use. To prepare the shape memory polymer (SMP), the reaction mixture formulated above was placed in a flat mold. The mixture is then heated in an oven maintained at atmospheric pressure and a temperature of 75° C. for 24 hours. After the material is cured for the specified period of time, it is removed from the oven and allowed to dry and cool down to room temperature. The materials are then removed from the mold and machined into the desired shapes.

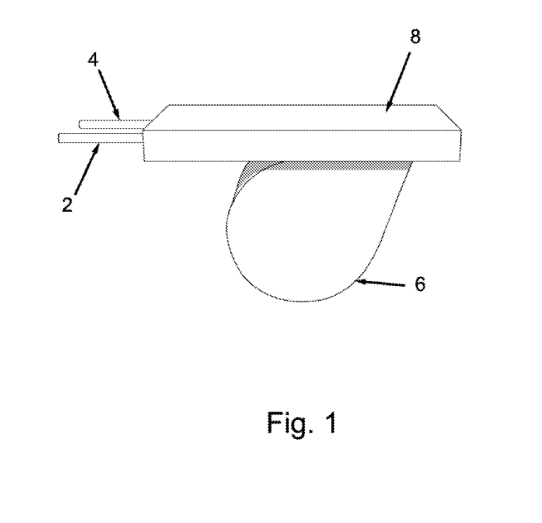

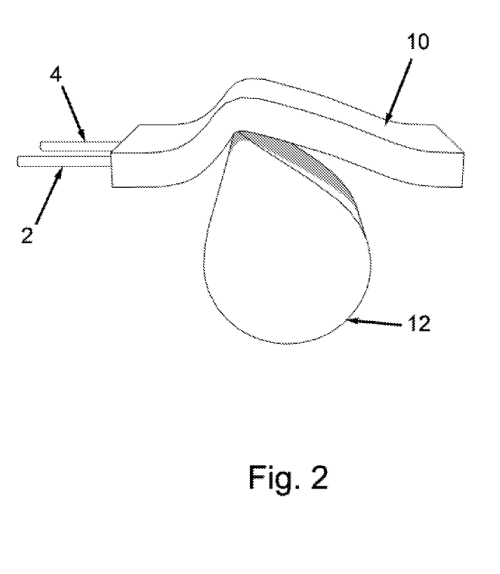

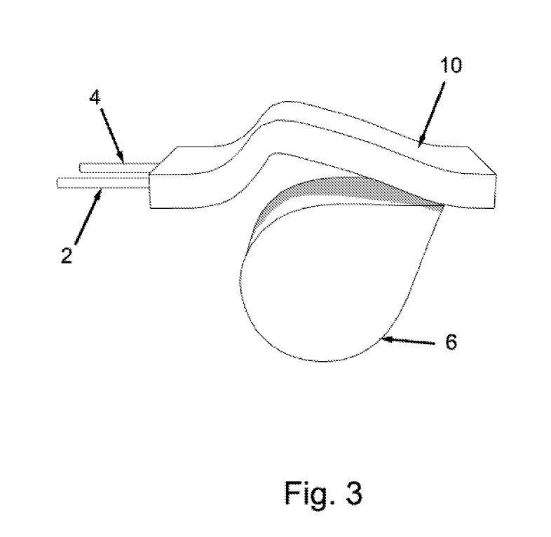

There are a wide variety of methods and means, which can be used to employ the currently disclosed device. The simplest of these embodiments is shown in FIGS. 1-3. FIG. 1 depicts the initial positions of an SMP bar, 8, and a mechanism which is desired to be moved, 6. Also shown in FIG. 1 are two wires, 2 and 4, which are electrically conductive and are used to electrically heat the SMP bar, 8. As seen in FIG. 1 the mechanism which is to be moved, 6, cannot be turned counterclockwise, because the SMP bar, 8, is in it's hard, rigid state. As seen in FIG. 2 the SMP once activated, 10, is now in a soft and pliable state and the mechanism, 12, can be moved with sufficient force in a counterclockwise manner. The electrical conductors, 2 and 4, conduct electricity through the SMP, 10, heating the SMP through resistive heating. Once the mechanism, 12, has been fully turned it maybe return to its original position, 6, as seen in FIG. 3. Additionally as seen in FIG. 3, the SMP, 10, remains deformed until current is again passed through the electoral conductors, 2 and 4, which will heat the SMP and allow it to returns to its memorized shape.

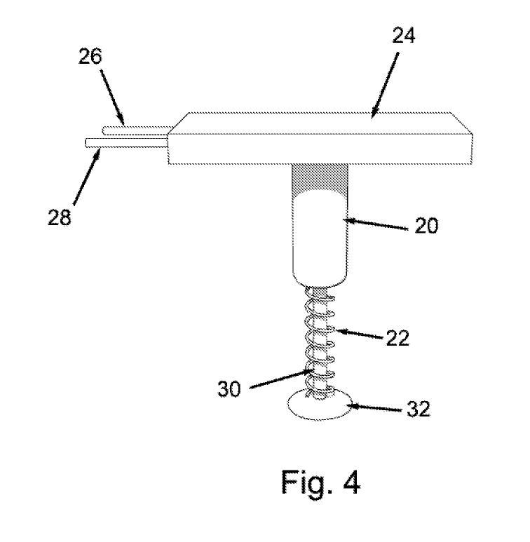

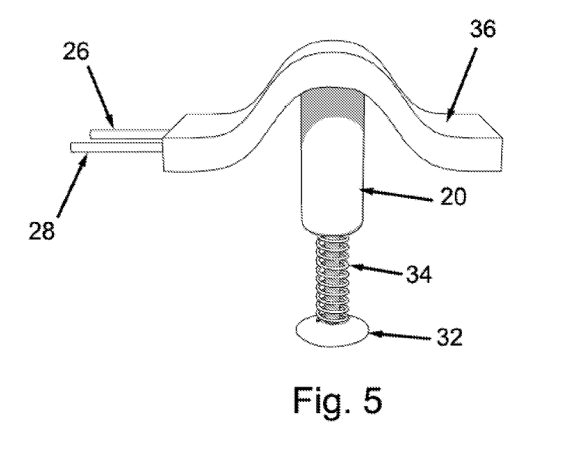

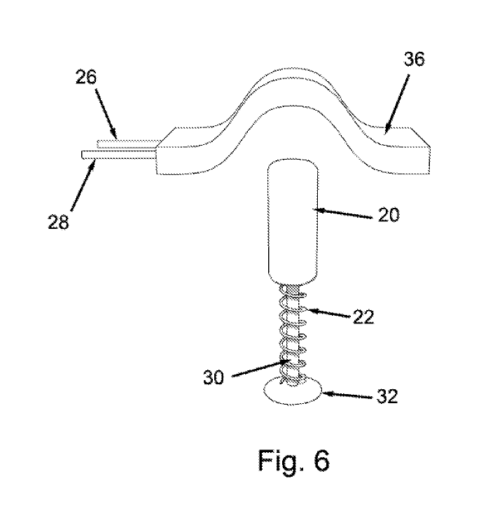

A second embodiment is shown in FIGS. 4-6. FIG. 4 depicts the initial positions of an SMP bar, 24, and a spring loaded, 22, pushbutton, 32, mechanism connected to a device, 20, which is desired to be moved. Also shown in FIG. 4 are two wires, 26 and 28, which are electrically conductive and are used to electrically heat the SMP bar, 24. As seen in FIG. 4 the mechanism which is to be moved, 20, cannot be moved with the SMP bar, 24, remains in it's hard, rigid state. The rod, 30, connecting the mechanism, 20, to the pushbutton, 32, retains its shape. As seen in FIG. 5 the SMP once activated, 36, is now in a soft and pliable state and the mechanism, 20, can be moved with sufficient force from the spring loaded pushbutton, 32. The electrical conductors, 26 and 28, conduct electricity through the SMP, 36, heating the SMP through resistive heating. Once the mechanism, 20, has been fully engaged, the force from the compressed spring, 34, will return the mechanism, 20, as seen in FIG. 6. Additionally as seen in FIG. 3, the SMP, 10, remains deformed until current is again passed through the electoral conductors, 2 and 4, which will heat the SMP and allow it to returns to its memorized shape.

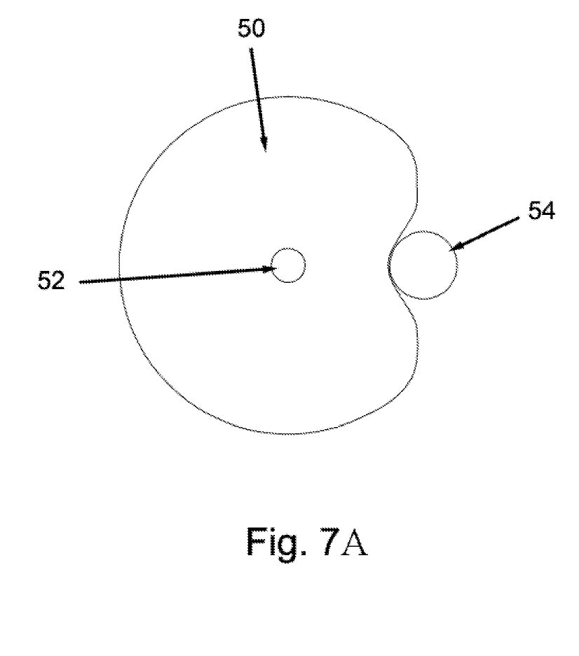

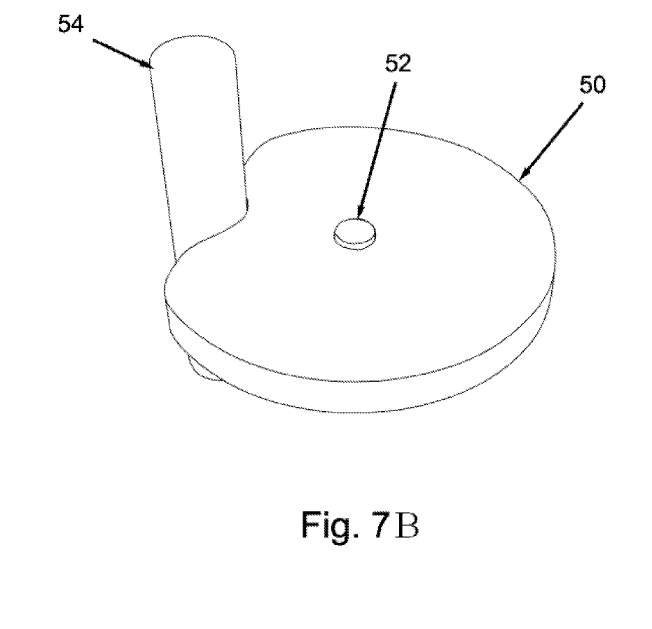

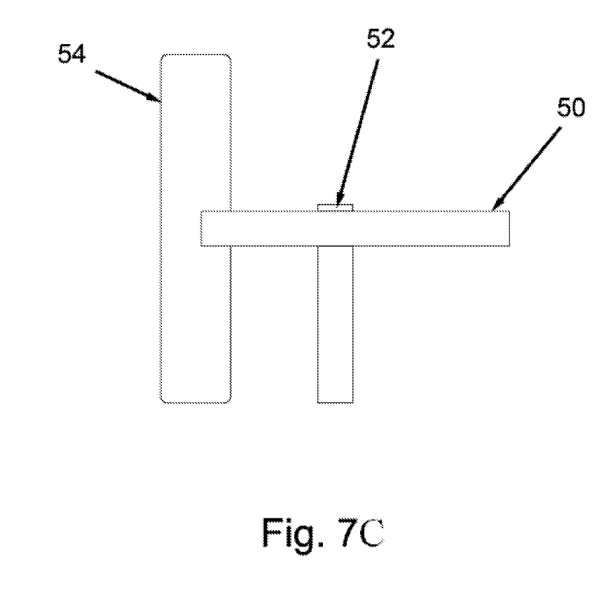

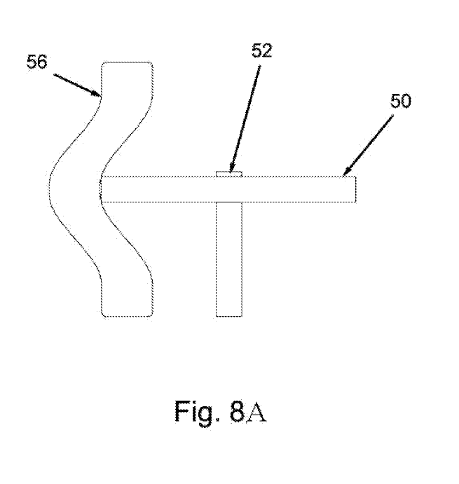

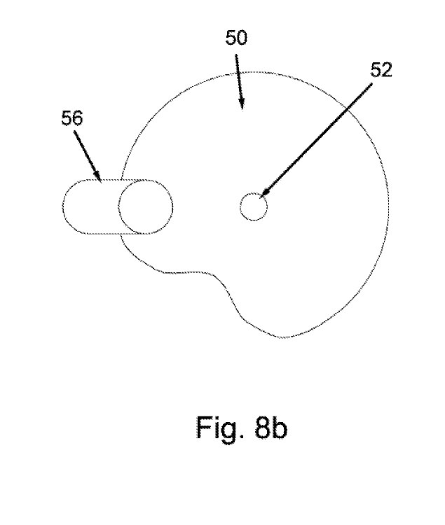

A third embodiment is shown in FIGS. 7A-7C, 8A, and 8B. FIG. 7A is a top down view of a cam, 50, held in place by a SMP bar, 54, in its rigid state. The cam, 50, will have a rotation force applied to it through the connecting bar, 52. The side view, as shown in 7C and the perspective view in 7B together show how the SMP bar, 54, prevents the cam, 50, from rotating while the SMP bar, 54, is hard and rigid. As shown in FIGS. 8A and 8B, once the SMP bar is activated becoming soft and pliable, 56, the cam, 50, may have sufficient force applied to it through the connecting bar, 52, to rotate. Once the cam, 50, has completed the desired number of rotations, the SMP bar, 54, can be deactivated returning it to a hard, rigid state.

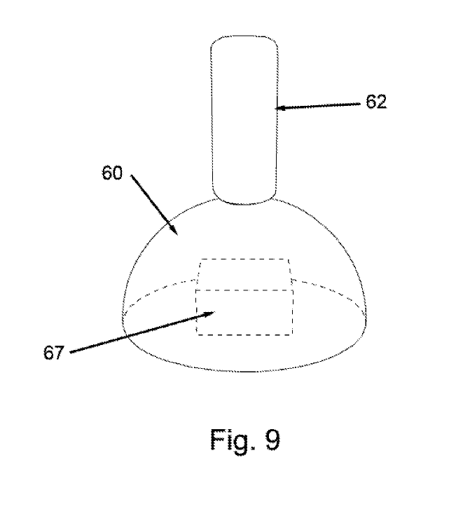

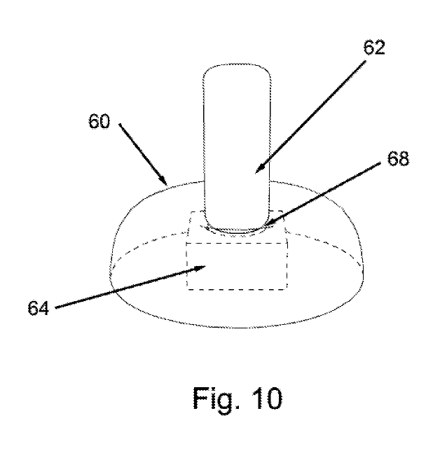

The SMP or shape memory material used in these devices need only provide a means for allowing and/or disallowing mechanical movement. However, the uses are not limited to simple mechanical locking mechanisms. As shown in. FIGS. 9-10 a device can be created to prevent or allow two items to contact each other. FIG. 9 shows a SMP shell, 60, surrounding a pressure sensitive device, 67, and a device, 62, which would apply pressure to the pressure sensitive device, 67, but cannot because the SMP shell, 60, is in a hard and rigid state.

The figures shown are in all respects as illustrative, and not restrictive, and the invention is not to be limited to the details given herein. While the disclosure has been described with reference to several exemplary embodiments, it will be understood by those of skill in the art that various changes may be made and equivalents may be substituted for elements thereof without departing from the scope of the present disclosure. In addition, many of the modifications may be made to adapt a particular situation or material to the teachings of the disclosure without departing from the essential scope thereof. Therefore, it is intended that the disclosure not be limited to the particular embodiments disclosed as the best mode contemplated for carrying out this discovery, but that the disclosure will include all embodiments falling within the scope of the appended claims.

What is claimed is:

1. A locking mechanism comprising a means for allowing and/or disallowing mechanical motion, wherein said means for allowing or disallowing mechanical motion comprises a shape memory material.

2. The locking mechanism of claim 1 wherein said shape memory material comprises a shape memory polymer.

3. The locking mechanism of claim 2 wherein said shape memory polymer is selected from the group consisting of a styrene shape memory polymer, cyanate ester shape memory polymer, maleimide shape memory polymer, and epoxy shape memory polymer.

4. The locking mechanism of claim 1 wherein said shape memory material is a shape memory polymer composite.

5. The locking mechanism of claim 1 wherein said shape memory material comprises a shape memory alloy.

6. The locking mechanism of claim 1 further comprising a means for activating said shape memory material.

7. The locking mechanism of claim 6 wherein said means for activating said shape memory material is thermal energy.

8. The locking mechanism of claim 6 wherein said means for activating said shape memory material is exposure to water, light, magnetic Fields, or electromagnetic radiation.

9. The locking mechanism of claim 5 wherein said means for activate said shape memory material is thermal energy generated from embedded electrical conductors.

10. The locking mechanism of claim 1 further comprising a means for deactivating said shape memory material.
